(19) United States
(12) Patent Application Publication
(10) Pub. No.: US 2002/0010866 A1
(43) Pub. Date: Jan. 24, 2002

(54) Method and apparatus for improving peer-to-peer bandwidth between remote networks by combining multiple connections which use arbitrary data paths

(76) Inventors: David J. McCullough, Upper Brookfield (AU); Wayne Meissner, Woolloowin (AU); Craig S. Humphrey, Auchenflower (AU); Christopher J. Biggs, Chapel Hill (AU); Antonio Basilio Merenda, Chapel Hill (AU)

Correspondence Address: Claude A. S. Hamrick, Esq, OPPENHEIMER WOLFF & DONNELLY LLP, 1400 Page Mill Road, Palo Alto, CA, 94304, US

(21) Appl. No.: 09/740,494

(22) Filed: Dec. 18, 2000

Related U.S. Application Data
(60) Provisional application No. 60/172,369, filed on Dec. 16, 1999.

(51) Int. Cl. H04L 12/22; H04K 1/00

(52) U.S. Cl. 713/201; 709/228

(57) ABSTRACT

A method and apparatus for increasing peer-to-peer bandwidth between remote networks by combining multiple connections, which use arbitrary data paths, is disclosed. The apparatus is a gateway node, which can be a specifically designed computer, open computer platform or extensions to firmware resident in a router; gateway or remote access server. The method includes origin authentication and data confidentiality, packet fragmenting, sequencing directed-routing, buffering, fragment encapsulation, packet re-assembly, and additional encapsulation for traversal of firewalls. Packet fragments transferred using the method can travel along very diverse paths through intervening public or private networks before arriving at the peer, which reassembles them. This eliminates the problems present in current aggregation schemes used by prior art, which are sensitive to the limitations in the infrastructure in the service provider's points of presence.

### CROSS-REFERENCE TO RELATED APPLICATIONS

This application claims priority to a U.S. provisional application entitled “METHOD AND APPARATUS FOR IMPROVING PEER-TO-PEER BANDWIDTH BETWEEN REMOTE NETWORKS BY COMBINING MULTIPLE CONNECTIONS WHICH USE ARBITRARY DATA PATHS” filed on Dec. 16, 1999, Ser. No. 60/172,369, which application is hereby incorporated by reference.

### FIELD OF THE INVENTION

The present invention relates generally to interconnecting private peer computer networks securely using a public computer network and aggregated multiple links between the private networks and the public computer network, where the aggregated multiple links improve the performance of the connection between the private peer computer networks.

### DESCRIPTION OF THE RELATED ART

Businesses today are commonly multi-site operations. Even within a given locale, it is very common for a business to have several buildings located some appreciable distance from each other. However, these businesses must stay in close communication not only through their telephone system but through their computer systems as well. Not only is there a requirement for communication among the multi-site operation but the communication must be fast, reliable, confidential, and, if possible, not too expensive.

FIG. 1 shows a multi-site operation between Los Angeles 10, Chicago 12, New York 14 and Atlanta 16, in which the various sites communicate by means of dedicated point-to-point links 18, 20, 22, 24, 26, 28 that comprise a wide-area network (WAN) 30. Each of the sites typically has a private network, such as one or more LANs (not shown in FIG. 1), on which it relies for internal communications. The point-to-point links interconnect these private networks, with the goal being to have the system appear to the users as a single, integrated system. However, to achieve this goal, the point-to-point links must operate at high speed. The common solution is to use dedicated leased lines, such as T1 lines, from the public telephone network. These dedicated leased lines are fast, reliable and confidential.

However, a dedicated WAN 30, such as that shown in FIG. 1, employing point-to-point leased lines between their private networks incurs high telecommunications tariffs and thus is a costly solution to the multi-site communications problem.

FIG. 2 shows an alternative approach to the problem, in which each site 10, 12, 14, 16 is connected to a public computer network 32, such as the Internet. This approach appears to be a viable alternative, but, in fact, lacks several requirements which a solution must meet. First, while the cost is low, because only local connect charges are incurred, the communications between the sites are not confidential. Second, the reliability of the computer network is sometimes a problem and third, the speed of the interconnection is highly variable and often to low for most businesses.

To solve the confidentiality problem, a virtual private network (VPN) can be established between the multiple sites. A VPN simulates some of the properties of a private network in the setting of a public network, such as the Internet, by sending data from one private network to the other through a tunnel (a secure private path) through the public network. A VPN arrangement means that each site only needs one network connection so there is a large cost saving compared with multiple dedicated circuits. Moreover, a VPN can connect sites located virtually anywhere in the world as long as there is access to the public network.

However, one problem that still remains even with the use of VPNs is the speed of the connection and in many cases this speed is limited not by the speed of the public network on which the VPN is established but the speed of the interconnection between the private site and the public network, which is typically not satisfactory for today's businesses.

A common interconnection between a private site and a public network, such as the Internet, is a PSTN dial-up connection on which the Point-to-Point Protocol (PPP) is run. PPP is a data link protocol that has been designed as the Internet standard for connecting (and disconnecting) a private host to the Internet Service Provider (ISP). Other physical links, such as ADSL and ISDN, can also be used, but the protocol remains PPP. These physical links still do not solve the speed problem sufficiently. It is highly desirable to have a facility for aggregating the physical links between the private host (via a router possibly) and the Internet so that high speed and selectable speed connections are possible using the common types of physical links that are available, the PSTN dial-up link being the most available.

A protocol that attempts to fill the need to aggregate physical links for a high speed connection is the Multi-Link Point-to-Point Protocol (ML-PPP). FIG. 3 shows ML-PPP being employed primarily by users desiring a high-speed dial-up Internet connections using ISDN. In this figure, there are two 64 Kbyte per second, ISDN B-channels 34, 36 which are aggregated into one 128 Kbyte per second channel. These connections couple the private network 38 via a router 40 to the public network 32, the Internet. For this arrangement to work, the customer premises equipment and the ISP PoP 42 dial-in equipment must both support ML-PPP.

However, this aggregation solution, while perhaps providing some relief to the speed problem, re-introduces the confidentiality problem. The protocol does not allow users to configure the bundled, dial-up Internet connections to securely tunnel private data through the Internet 32 between a local private network 38 and a remote private network 46, which is a requirement for a Virtual Private Network (VPN). In other words the confidentiality problem now exists between the private local and remote hosts and the Internet.

The Multi-Link PPP scheme creates a further problem. This problem, called the “Multi-link hunt group splitting problem,” occurs because the ML-PPP was not designed to handle an intervening network, such as the Internet, between the local private network and the remote private network. It was developed primarily to interconnect two or more networks directly by multiple point-to-point links to improve bandwidth.

Briefly stated, the problem is that PPP links within a bundle become dissociated by terminating at multiple intervening nodes rather than at a single node. Usually these nodes are Network Access Servers (NAS) that receive the dial-up calls. ISPs that offer ML-PPP allow dial-ins to the Point-of-Presence (PoP, a switching office of an ISP) using the same phone number for all of the links in the bundle. A rollover or hunt group of analog lines is commonly used for example to route all incoming calls to the available modem pools, NASs and routers. The primary and secondary connections in the Multi-link bundle thus may get established to different NAS or remote access concentrators on the internal network inside each PoP. The effect is that network nodes within the public network lose a needed association between the links in the bundle.

An existing protocol has been proposed to fix this splitting problem. One of these is the Layer 2 Tunneling Protocol (L2TP). LT2P extends the PPP model by allowing the link layer (layer 2) and PPP endpoints to reside in different devices interconnected by a packet-switched network. Using L2TP, the user has an L2 connection to an access concentrator (e.g., modem bank, ADSL, DSLAM) and the concentrator tunnels individual PPP frames (fragments) to a single Network Access Server (NAS). This allows the actual processing of PPP packets to be separated from the termination of the L2 circuit. The association between links in the bundle is preserved because the PPP fragments are recombined, by means of the tunneling, at a single device, the NAS or router.

Another protocol, the Point-to-Point Tunneling Protocol (PPTP) has also adopted this approach. However, despite these improvements problems still remain. Both solutions (L2TP and PPTP) require that the ISPs update their NAS software or router firmware in every device and in each of their PoPs, in effect placing the burden of aggregating PPP fragments on the PoP LAN backbone that interconnects the L2 access device and the NAS. This result is simply unworkable for several reasons.

First, placing the burden of aggregating PPP fragments onto the PoP LAN introduces additional latency and possibly performance bottlenecks. Second, all of the ISPs PoPs must support ML-PPP with fragment recovery. The likelihood of the latter being met, especially where there are international tunnel connections and different ISPs, each with potentially different equipment, is very low. Third, ML-PPP configurations and connection types are limited, inconsistent or totally non-existent at locations serviced by ISPs. Some ISPs offer ML-PPP connections over ISDN using the Basic Rate Interface (BRI). Some ISPs that offer higher speed ISDN connections require that each site have a router that includes proprietary multi-chassis ML-PPP extensions that are consistent with the equipment at their PoPs. Sometimes ISDN is not even available to the private host or network that needs to connect to the Internet.

This leaves the operator of the private site or network without a guaranteed solution that can easily improve bandwidth between remote locations regardless of whether they are using analog, digital or a combination of connections to the Internet.

Thus, there is a need a low-cost, high-speed, scalable-speed, confidential connections between the private networks of multiple, geographically dispersed sites that have the approximately the same characteristics as private, high-speed point-to-point links interconnected between those sites.

### BRIEF SUMMARY OF THE INVENTION

The present invention is directed towards such a need.

The present invention establishes a virtual private network (VPN) between two edges of a public computer network and connects each of these edges to a private network to permit communication between the private networks.

One advantage of the present invention is that it provides high speed and scalable bandwidth to businesses requiring site-to-site connections between their private Local Area Networks.

Another advantage of the present invention is that IP datagrams can be split, recombined and sequenced across an arbitrary number of dial-up Internet connections regardless of how the IP packets traverse the Internet and without being limited by the equipment at the PoP or any other Internet nodes. This makes the present invention independent of the particular ISP's access equipment so that links can be spread across multiple ISPs for increased reliability should a PoP fail.

A further advantage of the present invention is that data can be transferred between private networks using a variety of connection types between the private network and the Internet Service Providers at each location. These connection types include analog modem (PSTN), ISDN, ADSL or leased-line T-1 links.

Yet another advantage of the present invention is that a high level of resilience can be maintained because a dropped or failed connection can be re-established while the VPN is operating.

Yet another advantage of the present invention is that bandwidth is configurable by setting connection throughput thresholds and can be tuned for the best performance and the lowest ISP charges.

Yet another advantage is that the present invention can combine multiple Internet connections from a site or spread them across a variety of PoPs.

Yet another advantages is that the present invention can operate in a “many to one” scenario in which a large number of sites use multiple connections to improve bandwidth between them and a central site that employs one or more high-speed connections.

Yet a further advantage is that the present invention can ensure that the tunneled data can traverse the majority of routers and firewalls within the Internet successfully, even if they restrictive and only allow a set number of protocols to pass.

### BRIEF DESCRIPTION OF THE DRAWINGS

These and other features, aspects and advantages of the present invention will become better understood with regard to the following description, appended claims, and accompanying drawings where:

FIG. 1 shows a multi-site operation between Los Angeles, Chicago, New York and Atlanta, in which the various sites communicate by means of dedicated point-to-point links that comprise a wide-area network (WAN);

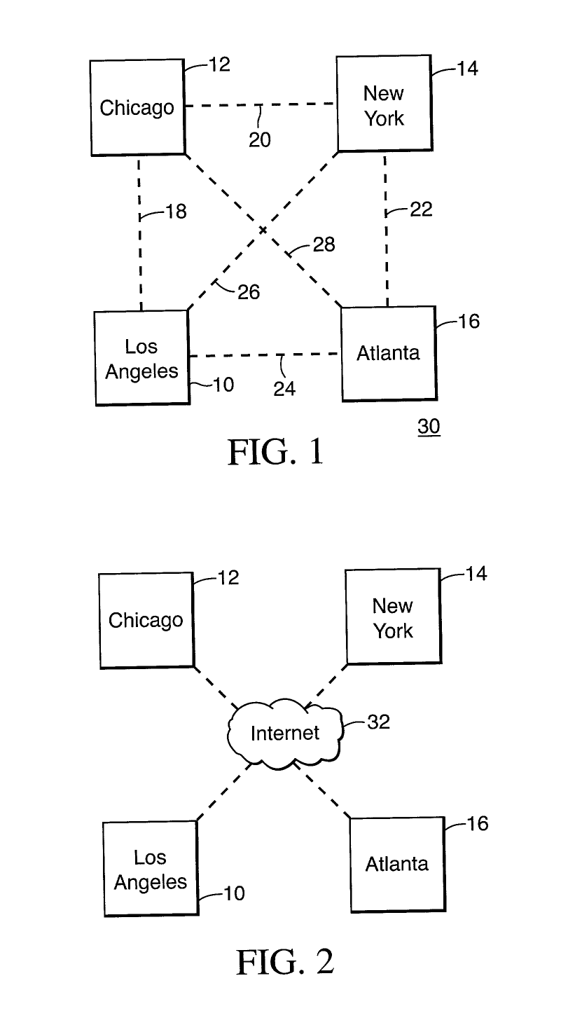

FIG. 2 shows an alternative approach to the problem, in which each site is connected to a public computer network, such as the Internet;

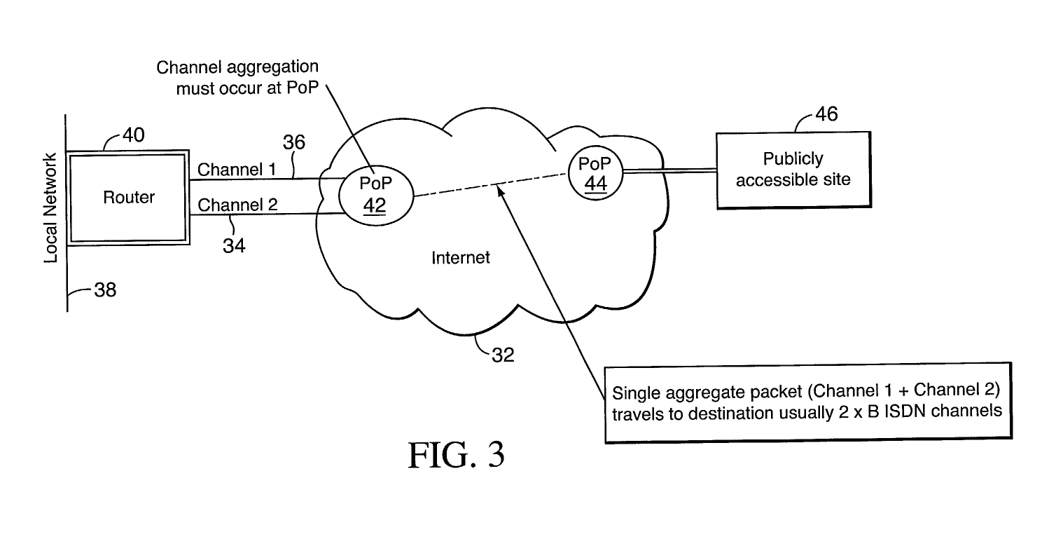

FIG. 3 shows ML-PPP being employed primarily by users desiring a high-speed dial-up Internet connection using ISDN;

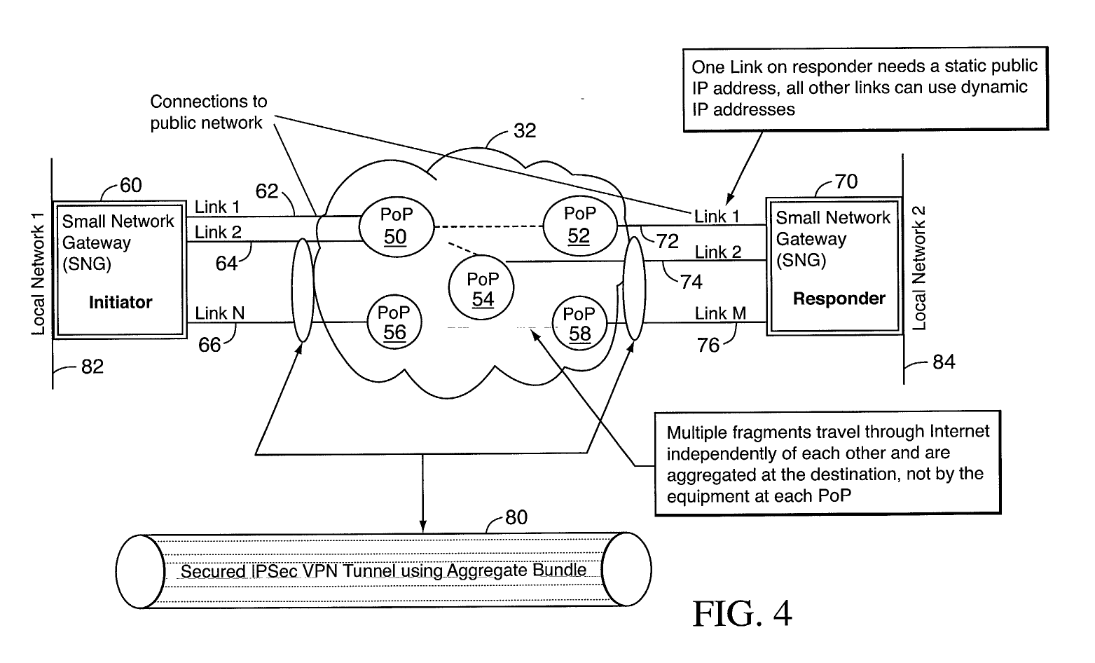

FIG. 4 is a simplified diagram of a system in accordance with the present invention;

FIG. 5 illustrates an IP packet that is secured by the IPSec Protocol using ESP services in tunnel mode;

FIG. 6 shows the fields of a standard IP Packet Header. Standard IP fragmentation is used in the present invention;

FIG. 7A illustrates the several blocks that cooperate to carryout important functions of the present invention;

FIG. 7B shows the protocol stack for SVC and the IVCs that comprise the SVC;

FIG. 8 shows a fragmented tunnel data packet with TCP encapsulation;

FIGS. 9A and 9B show a flow chart of the process for transferring packets from a private LAN, through the gateway to the Public Network;

FIGS. 10A and 10B show a flow chart that illustrates the process of receiving a packet over the VPN;

FIG. 11 shows a flow chart of the TCP encapsulation sequence;

FIG. 12 shows a flow chart of the process for negotiating additional IVCs for a SVC;

FIG. 13 shows a block diagram of a gateway system, in accordance with the present invention;

FIG. 14 shows a typical system that can be supported by the Small Network Gateway;

FIG. 15 shows another typical installation that can supported by the SNG; and

FIG. 16 an alternative embodiment of the present invention which includes a standard or industrial server PC computer for high capacity implementations.

### DETAILED DESCRIPTION OF THE INVENTION

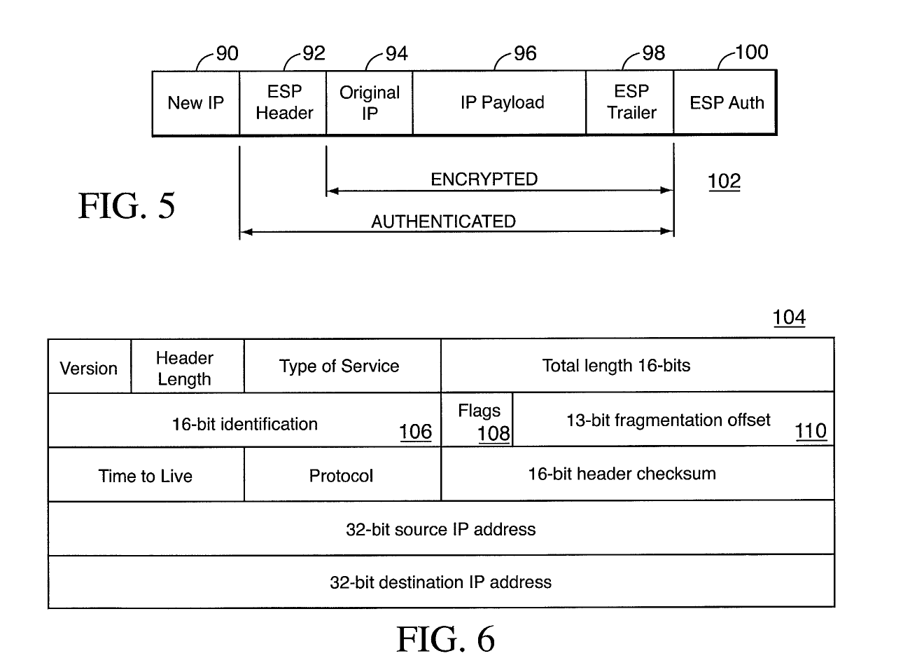

FIG. 4 is a simplified diagram of a system in accordance with the present invention. A public computer network, such as the Internet 32, is represented by the cloud-shaped figure. The public network includes one or more Points of Presence (PoP) 50, 52, 54, 56, 58 for one or more Internet Service Providers. An Initiator device (also referred to as a gateway) 60 is connected to one edge of the public network 32 by means of one or more links, ILink 1-N 62, 64, 66, of a first set of links. Each link 62-66 of the first set terminates at a one of the PoPs 50, 56 within the public network 32. A Responder device (also referred to as a gateway) 70 connects at another edge to the public network 32 by means of one or more links, RL1-N 72, 74, 76, of a second set of links. Each link 72-76 of the second set of links terminates at one of the PoPs 52, 58 within the public network 32. One link that interconnects the Responder and the public network must have a static Public IP address, but the other links of the second set can use dynamic IP addresses. A Virtual Private Network 80 is established between the Initiator 60 and the Responder 70 and includes one of the first set of links, the public network and one of the second set of links. The VPN connects a private network 82 connected to the Initiator 60 to the a private network 84 connected to the Responder 70.

The Virtual Private Network is a tunnel between the Initiator and Responder that is implemented using IPSec, the Layer 3 security protocol for the Internet, operating in tunnel mode. Information is available regarding the Internet Security Protocol (IPSec) from IETF (the Internet Engineering Task Force, a standards setting body for the Internet). However, a brief description of the protocol follows.

The IPSec Protocol is a protocol to provide security services on IP networks. The protocol operates at Level 3, the network layer. IPSec provides a choice of two kinds of security services, an authentication service and a confidentiality (security) service. It also provides for an Internet Key Exchange that allows parties to negotiate methods of secure communication through special exchanges, known as security associations (SA). The parties of the security association agree on encryption methods, lock and unlock keys and the useful life of the key.

The authentication service attempts to guarantee that the sender is actually the sender named in the transaction. This service is directed towards preventing imposters from intruding in a communication process between other parties. The IPSec protocol implements the authentication service by means of an Authentication Header (AH). When a packet is sent out a hash function is performed over the entire packet based on the contents of the packet and a known key. The result of the hash is included in the Authentication Header. The hash will fail if the contents of the packet have been altered when the packet is checked by the receiver.

The confidentiality or security service of IPSec attempts to ensure that only the two ends involved in the communication will be able to decipher the contents of a message that has been encrypted for security purposes. The IPSec Protocol implements the security service by means of the Encapsulating Security Payload (ESP) header. In this case, a packet is encrypted using an agreed upon encryption algorithm with keys that are known to both the sender and the receiver.

The IPSec Protocol has two major modes of operation, the transport mode and the tunnel mode. The transport mode is used to add security to packets traveling between two IP systems. The tunnel mode provides security services between two IP systems that act as Security Gateways (SG). In the tunnel mode an original IP packet is encapsulated in an IPSec header and then sent from one security gateway to the other gateway which upon receipt of the packet, uses the IPSec header for security purposes and recovers the original IP packet. Thus IPSec provides level 3 tunneling because the payload of the IPSec packet is IP traffic.

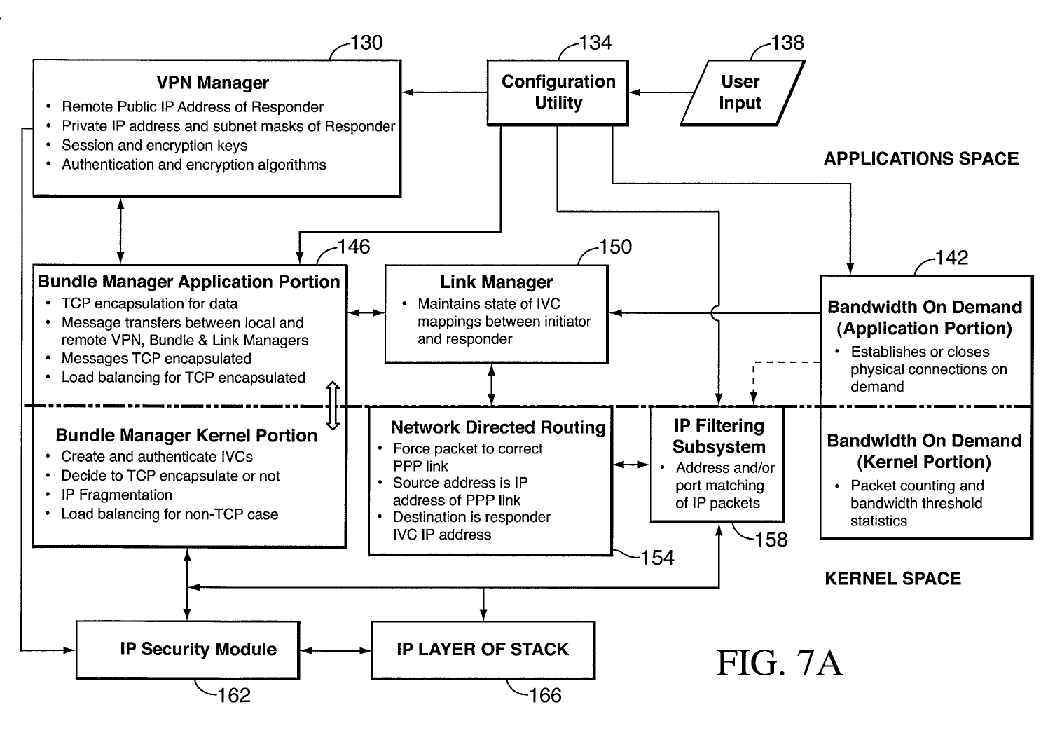

FIG. 5 illustrates an IP packet that is secured by the IPSec Protocol using ESP services in tunnel mode. The diagram shows the portion of the packet 94, 96, 98 that is encrypted and the portion of the packet 92, 94, 96, 98 that is hashed for authentication. The components of the secured IP packet include a New IP header 90, an ESP header, 92 an original IP header 94, the IP payload 96, and ESP trailer 98, and ESP Authentication trailer 100. This IPSec packet 102 then can be used to carry IP addresses used on private site LANs from one site to another, through the public network, in effect, hiding the private source and destination addresses of the LAN from users on the public network.

Thus, the IPSec ESP tunnel mode provides site-to-site security between two gateways that are separated by the public network. However, the IPSec ESP Tunnel mode does not provide a way to treat multiple tunnels between an Initiator and the Responder as a unified channel or bundle having a bandwidth that is the aggregate of the bandwidth of the individual tunnels.

The present invention provides the facilities to, in fact, treat multiple tunnels between the Initiator and Responder as a unified channel. Such a unified channel is called a superior virtual circuit (SVC) and the individual tunnels are called inferior virtual circuits (IVCs). An IVC is a peer-to-peer connection between an initiator and responder that includes a PPP link between the initiator and the public network, a connections through the public network, and an equivalent PPP link between the responder and the public network.

A necessary condition for treating the IVCs as a unified channel is that the packet load must be distributed approximately equally over each the IVCs. If this condition were not met, some of the IVCs would take most of the load causing saturation of those IVCs while other IVCs would stand idle. This unbalanced condition would not lead to a SVC whose bandwidth is approximately the aggregate of the individual bandwidths of the IVCs, nor one that would have scalable bandwidth.

One way to balance the packet load over the IVCs is to fragment a tunnel source packet and to distribute the smaller packets across available IVCs to share the load equally. This enables the fragments of the original tunnels packet to travel down multiple paths simultaneously, across the public IP network, to the eventual peer destination.

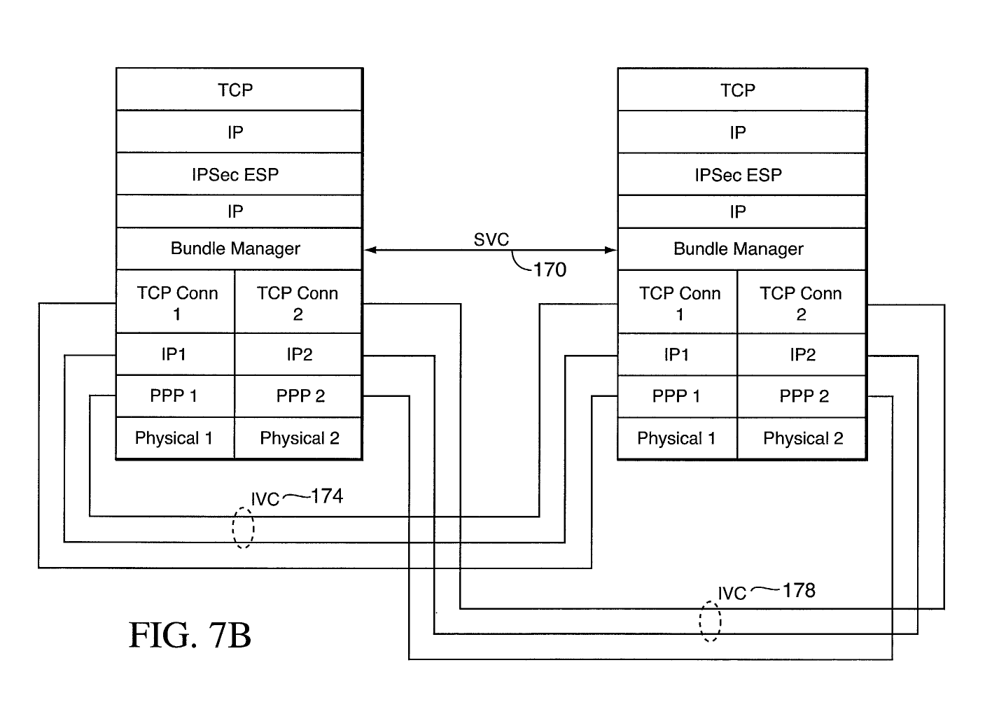

FIG. 6 shows the fields of a standard IP Packet Header 104. Standard IP fragmentation is used in the present invention. Fields in the IP header contain information regarding fragmentation and re-assembly. The identification field 106 contains a unique value for each IP packet. This is replicated in each fragment. The flags field 108 uses a bit, which is turned on for each fragment except the final fragment. The fragment offset field 110 contains an offset in 8 byte units of the particular fragment from the beginning of the original packet. When a packet is fragmented, the total length field of each fragment is changed to be the size of that fragment. When an IP packet is fragmented, each fragment becomes its own smaller packet with its own IP header and is routed independently of any other packets. This means that fragments can arrive out of order. However, there is appropriate information in the IP header to reassemble the fragments at the destination.

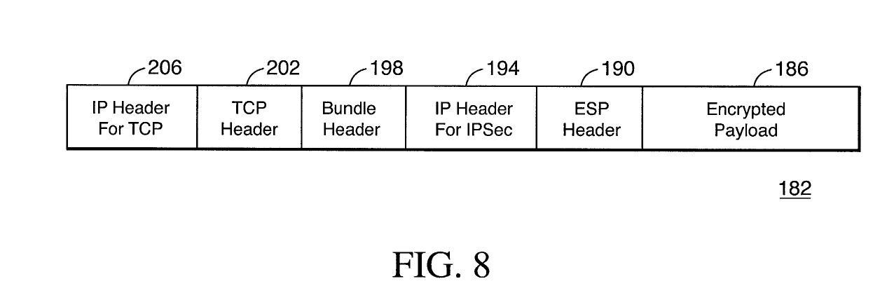

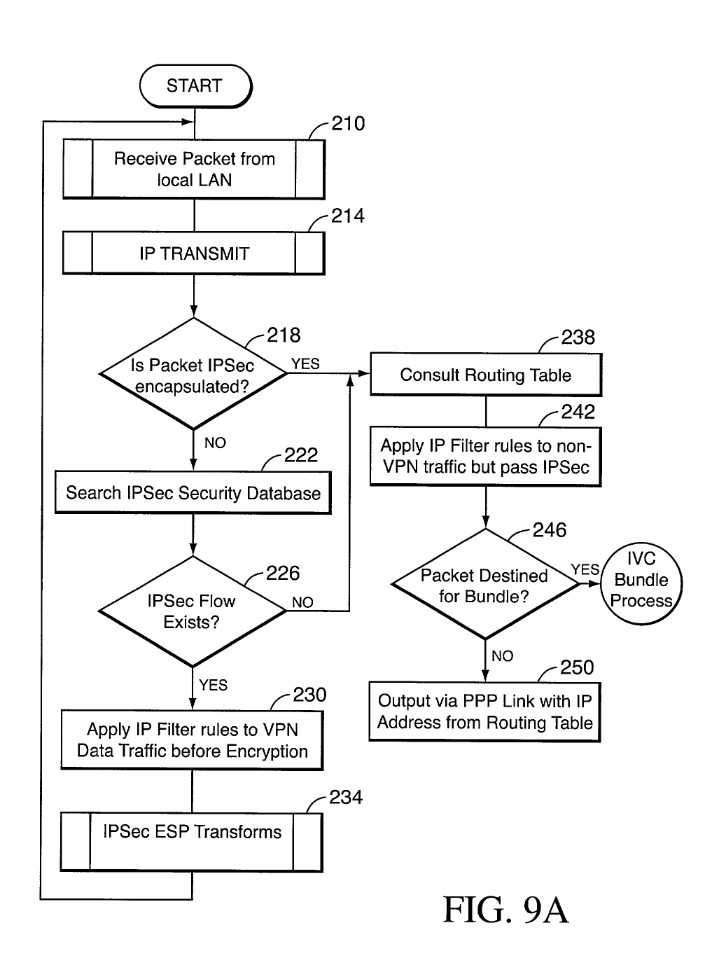

FIG. 7A illustrates the several blocks that cooperate to carryout important functions of the present invention. These blocks include a VPN Manager 130, a Configuration Utility 134, which receives User Input 138 and connects to a Bandwidth-On-Demand Module 142, a Bundle Manager 146, a Link Manager 150, a Network Directed Routing module 154, a IP Filtering Subsystem 158, a IP Layer of the Protocol Stack 166 and a IP Security Module 162. Part of the Bundle Manager 146 and the Bandwidth-On-Demand 142 module reside in the Application space; the other part of each resides in the operating system (the kernel) space.

The VPN Manager 130 receives information from the Configuration Utility 134 and is connected to communicate with the Bundle Manager 146. The Configuration Utility 134 receives user configuration information which it uses to parameterize the VPN Manager 130, the Bundle Manager 146, the IP Filtering System 158 and the Bandwidth-On-Demand Module. The Bundle Manager connects between VPN Manager and the IP Security Module 162 and the IP Layer 166 of the Stack to carry out its functions. The Link Manager 150 connects to the Bandwidth-On-Demand module 142, the Bundle Manger 146 and the Network Directed Routing Module 154. The IP Filtering System 158 connects to the IP Layer 166 and IPSec Layer 162 to filter IP packets.

The VPN Manager 130, Link Manager 150, and Bundle Manager 146 of an Initiator each communicate with their counterparts in the Responder. These messages are peer-to-peer messages, the VPN Manager of the Initiator communicating with the VPN Manager of the Responder, the Link Manager of the Responder communicating with the Link Manager of the Responder, and the Bundle of the Initiator communicating with the Bundle of the Responder. Messages are always sent and received by the Bundle Managers 146 and the messages are always TCP encapsulated to assure their safe transfer.

Configuration Utility

To configure a gateway, a Web server is included in the gateway. Using a standard browser, such as Internet Explorer or Netscape Navigator, a graphical configuration utility 134 can be invoked by the operator.

With the graphical configuration utility, an operator can configure all aspects of the gateway from a workstation connected locally to the private network to which the gateway is connected. The configuration utility imposes a hierarchy of connection details, starting from the physical links and moving up to the SVC. In particular, the operator must configure:

The network interface setup (dialup serial port and Ethernet port for the private network);

The external links or dialers which include port speed and ISP account details;

Bundles, which aggregate a number of links; and

A VPN tunnel to the remote private site using a particular bundle and security parameters.

The VPN tunnel also has a descriptive header such as the name of the remote private site. Tunnel end point IP addressing, remote IP sub-net addressing, public remote static IP address, security parameters including IPSec authentication algorithms, and session and encryption keys can be entered using the configuration utility. The VPN tunnel can also have a traffic filter applied so that only specific private data can travel over the tunnel between the private sites.

Each external link requires a descriptive identifier such as the name of the ISPs used. Bundles also have a descriptive identifier. Bundles can have a traffic filter applied to them to restrict the general Internet traffic that is allowed to travel, via the gateway, between the private network and the public network. Bundles also have bandwidth control parameters that govern when links are added or dropped based on the fraction of total link capacity that a given link is carrying.

The VPN Manager

The VPN Manager 130 is a repository of parameter information that other modules in the system must have access to. The VPN manager knows the remote public IP address of the Responder (a fixed IP address) as well as the private IP address and subnet masks (the private side) of the Responder. The VPN manager also keeps the session and encryption keys and the authentication and encryption algorithms for the VPN. These keys are received manually from the configuration utility but it is also contemplated that the keys can be obtained automatically by using digital certificates or other similar system. The VPN manager also has the capability to turn the VPN on and off.

An Initiator VPN Manager can send a Connect_Request to a Responder VPM Manager. This request contains the source and destination request of the IPSec VPN tunnel, encryption and authentication algorithms. The Responder VPN responds with a VPN Connect_Reply containing a failure or success indication. A failure indication is sent if there requested algorithms are not recognized by the Responder.

The Bundle Manager

The main job of the Bundle Manager 146 is to fragment and defragment packets sent over the SVC. The Bundle Manager also provides a service of managing peer-to-peer message traffic (data and control messages) between the VPN Manager, Bundle Manager, and Link Manager of the Initiator and Responder and it provides TCP encapsulation of the data to assure that the tunnel data packet fragments can pass through the majority of firewalls and routers which may otherwise discard IPSec packets. Peer-to-Peer control messages between the VPN, Bundle and Link Managers are always TCP encapsulated to assure reliable message communication.

The Bundle Manager also handles tasks of creating and validating IVCs, end-to-end, between a pair of gateways (Initiator and Responder).

Associated with the task of fragmenting packets is the task of distributing these packets over the available IVCs to implement load sharing.

The bundle manager fragments a packet by comparing the size of the packet with the transmission unit (MTU), which for underlying PPP links is 1500 bytes. The fragmented IP packet is not reassembled until it reaches its final destination. Therefore, if there are several hops to the destination, an intermediate device does not need to participate in any re-assembly.

In the gateway device, the fragment size is set at configuration time to 50% of the PPP MTU, but this setting can be overridden. However, the upper limit is the full MTU. In the case where there is a large transfer of tunnel data between peers, then the bundle manager can distribute a 1500 byte fragment on each available link in a round-robin fashion. The more likely scenario is that numerous small transfers are interleaved with fewer large transfers. The fragment size can be tuned for different circumstances to achieve the best aggregate throughput.

The Bundle Manager 146 is split into two parts, the Application Portion and the Kernel Portion. The Bundle Manager Application Portion handles the tasks of TCP encapsulation of data, TCP encapsulated Message Transfers between local and remote VPN Mangers, Bundle Managers and Link Managers, and Load Balancing for TCP encapsulated messages. The Bundle Manager Kernel Portion handles the tasks of creating and authenticating IVCs, deciding whether or not to TCP encapsulate, IP Fragmentation and Load balancing when there is no TCP encapsulation.

A Connection_Request is made from the Initiator Bundle Manager with the name of a bundle. The Connection_Request includes a request for a new bundle or a request to join an existing bundle. A Connection_Reply is send from the Responder Bundle Manager with a successful result indication or a fail indication.

The above messages, such as Connection_Request and Connection_Reply and others that are sent by the Bundle Manager message facility, require a connection-oriented, reliable byte-stream service. Each application, in this case an Initiator and Responder, must establish a TCP connection with each other before exchanging messages or data. Each TCP unit of information or segment contains a source and destination port number to identify the sending and receiving application. Many port numbers are standardized and managed by the Internet Assigned Numbers Authority. There a many spare unassigned port numbers used by networking applications.

The port value along with the source and destination IP address uniquely identify each connection and the combination is usually referred to as a socket. A gateway (Initiator or Responder) uses TCP port 2000 for messages or messages and data, if TCP encapsulation is required.

The Link Manager

The Link manager 150 resides in the user (or application) space and has the task of negotiating and maintaining IVC mapping in conjunction with a bandwidth-on-demand subsystem, described below. To negotiate and maintain the IVC mappings, the link manager creates an association between IVCs at the Initiator and the Responder. If a gateway device requests more links to increase the gateway's SVC bundle capacity, the link manager for the gateway requests additional links from the remote peer link manager through messages, described below, passed over an established IVC. If the request for additional links is successful, each link manager updates the new IVC mappings to maintain the additional peer-to-peer IP connections. In this way, each site can effectively discover and use the maximum number of peer-to-peer links available to ultimately provide the largest capacity SVC. The link manager communicates with the bundle manager to notify the bundle manager of any new IVCs and the bundle manager transfers messages to send and retrieve information required for the link manager.

The simplest case of IVC mappings is the case in which there are the same number of links at each site. The association is then one-to-one. If there are more links at one site than the other site, then the link manager associates already allocated links at the site with fewer links with the links at the other site.

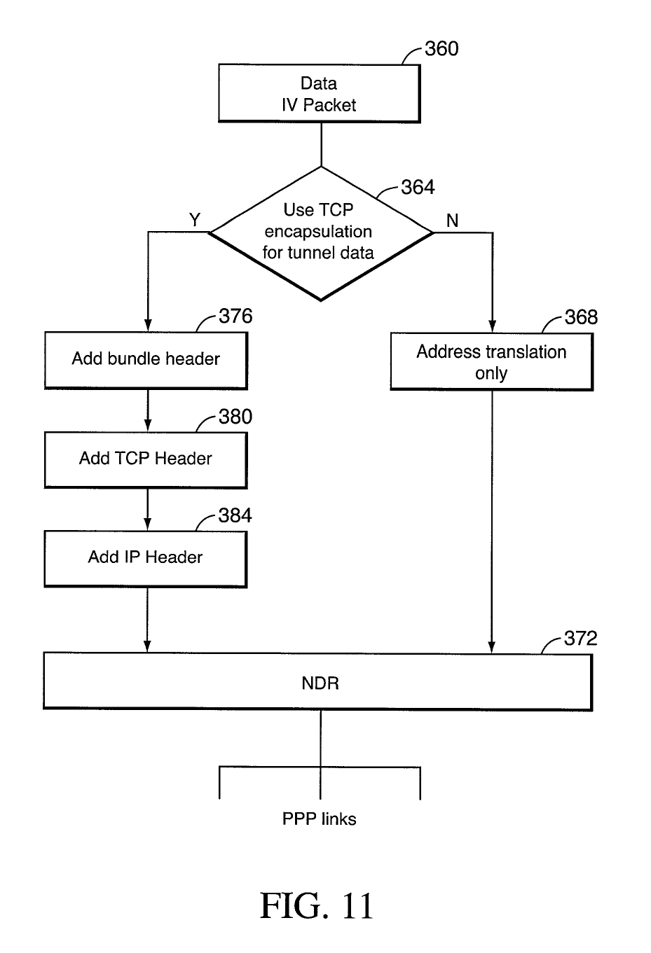

The Link manager 150, additionally, maintains the state of network-directed routing (NDR). In the case where there is no TCP encapsulation of tunnel data packet fragments, the link manager relies on different mechanism to direct tunnel packet fragments. Instead, the link manager modifies the source and destination addresses of the tunnel data packet fragment to ensure that the packet fragment, destined to arrive at particular link, has valid IP addressing for that IVC and then NDR steers the packet fragment to the appropriate network interface. See FIG. 11 and discussion below. This will enable the packet fragment to pass through firewalls and routers, thus forwarding the packets associated with that link as long as these firewalls and routers do not discard packets with IPSec identifiers. The operator of a gateway would manually verify that TCP encapsulation is not required. Typically, TCP tunnel data encapsulation would first be chosen to confirm secure tunnel communication between sites using multiple PPP links and ISP accounts. It would then be disabled to later confirm that the ISP's routers or firewalls or any intermediate devices do not block the tunnel data packet fragments because of their IPSec protocol identifiers.

An Initiator Link Manager can send a Link_Add Request or a Link Authenticate Response.

A Link_Add_Request contains a source IP address of the Initiator end of the IVC. The Link Manager of the Responder replies to the Initiator using a Link_Add_Reply message that contains a remote IVC IP address and a result code indicating success or failure of the Link_Add_Request. Failure occurs when there are no additional links available. After this message exchange, the IVC exists but cannot be used until it is authenticated.

A Link_Auth_Response from the Initiator answers a LinkAuthenticate Challenge message from the Responder. The challenge is based on a hashing algorithm. The Link Manager of the Initiator replies with a Link_Auth_Response and the Responder replies with a reply indicating whether the challenge was successful or not. If the challenge was successful, the IVC exists and is authenticated.

The Network Directed Routing

The Network Directed Routing 154 forces a packet having a particular IVC address to be routed to a particular PPP link by setting a packet source address to the IP address of the Initiator PPP link and the destination address to the IP address of the Responder PPP link. NDR solves a problem that arises when there are multiple IVCs. The problem is that the IP stack would send all packets destined for external addresses out only one of the PPP links, that link being the default link. Some IVC packets would have the correct source and destination address for the Initiator and Responder PPP links and some would not. The incorrect ones would be dropped by the ISP. NDR corrects this problem by forcing packets that are destined for an IVC, which are matched by the IP Filter System, to travel out the correct PPP link. With NDR, the ISP views an NDR-steered packet as a normal PPP packet with the correct addressing for a link. The NDR system adds a new level of packet direction for SNGs with multiple IVCs to ensure that the correct packets travel on the correct circuit and the correct PPP link. NDR uses the IP Filtering Subsystem 158 to match packets with the correct IVC IP address supplied by the Link manager 150.

The IP Filtering Subsystem and Bandwidth on Demand Subsystem

The IP Filtering Subsystem 158 can match the address and UDP or TCP port number of any packet to control the type of traffic (IP or TCP), such as e-mail, private tunnel, Web, FTP, or multimedia traffic, that is allowed to flow between the private network and the public network via the gateway, based on the user input from the Configuration Utility 134 and optionally, on input from the Bandwidth-On-Demand System 142. Filtering allows the gateway system to prevent certain kinds of traffic from traveling through the gateway and helps determine the type of traffic that is permitted to travel through the gateway from the public net. The IP Filtering Subsystem matches the address and UDP or TCP port numbers of internal (LAN) or external (Public Network) IP Packets. The NDR 154 relies on the IP Filtering System 158 to carryout some of its functions.

The Bandwidth on Demand module 142 is sensitive to the type of IP traffic allowed through by the IP Filtering Subsystem. Threshold settings in the gateway can be used to invoke dialup links and the type of traffic that is allowed to pass can be configured in the gateway. Regarding threshold settings, each link has upper and lower usage thresholds, expressed as a maximum speed of the physical interface. When set appropriately by an operator these thresholds can throttle the data capacity of the SVC such that if traffic drops below a certain level then a link may drop or if traffic hits a certain upper threshold, then a new link can be added to carry additional traffic through the SVC. The Bandwidth on Demand 142 and Internet Packet Filtering modules 158 can therefore cause a modem to dial an ISP based on the usage threshold or IP packet type. The additional dial-up connection will establish another PPP link, and if configured correctly, force the eventual creation of an additional IVC which joins the current SVC bundle via the link and bundle managers. The PPP links can be set for static operation which means that they are always active regardless of the usage on each of them.

FIG. 7B shows a protocol stack to illustrate the SVC 170 and the IVCs 174 178 that comprise the SVC. The Bundle Manager interoperates with the IP layer in the protocol stack to provide the appropriate IP addressing, routing and/or translation to transfer packets between gateways. Part of the bundle manager resides in the gateway operating system space and communicates directly with the IP layer, while another portion (the portion that provides optional TCP encapsulation) of the bundle layer resides in the user space.

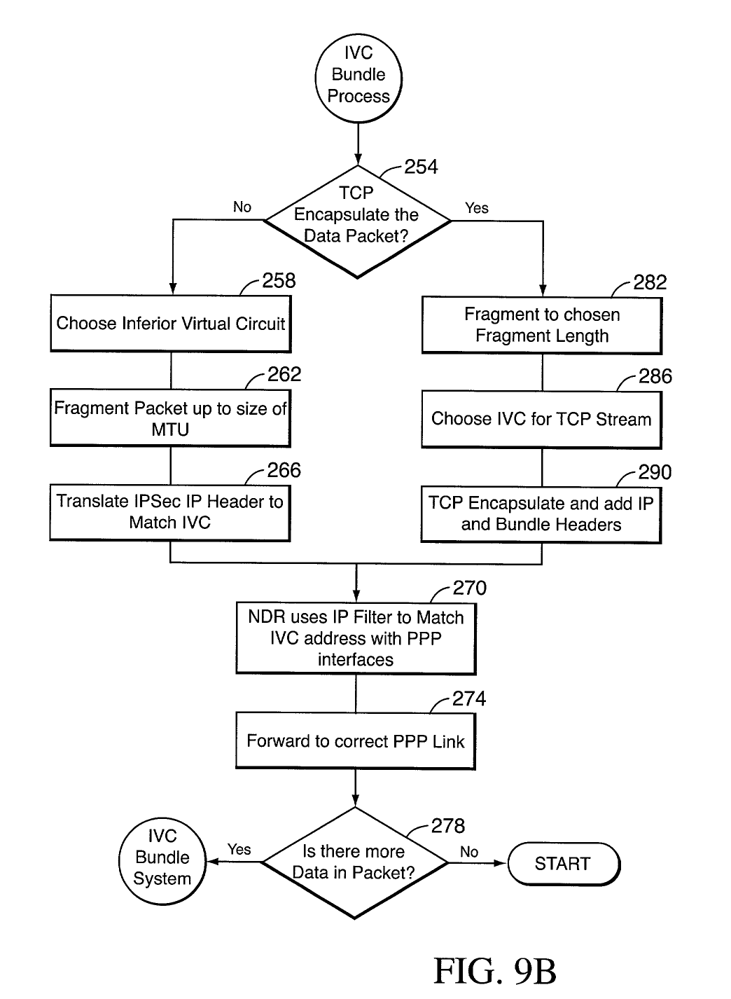

FIG. 8 shows a fragmented tunnel data packet 182 with TCP encapsulation that a protocol stack such as shown in FIG. 7B produces. In this figure, the payload 186 is encrypted and an ESP header 190 is prepended. Then an IP header 194 is prepended to the ESP header 190. The IP Header 194 allows the IPSec Packet to tunnel through the network between gateways. Next, a bundle header 198 194 is prepended to the IP header. The bundle header is a 16 byte header in which 4 bytes indicate a valid packet, 4 bytes contain a message ID, 4 bytes contain a message type and 4 bytes indicate a message length, including the header itself. The bundle header is used on tunnel data packets only if TCP encapsulation is used and it is always used on messages transferred between gateways in order to maintain the state of IVCs. After the bundle header 198 is prepended, if TCP encapsulation is required, a TCP header 202 is prepended and then the IP header 206 is prepended to the TCP header. The IP header 206 encapsulates the TCP Header 202. This makes the packet adhere to the Transmission Control Protocol of the Internet Transport layer and the Internet Protocol of the Network Layer.

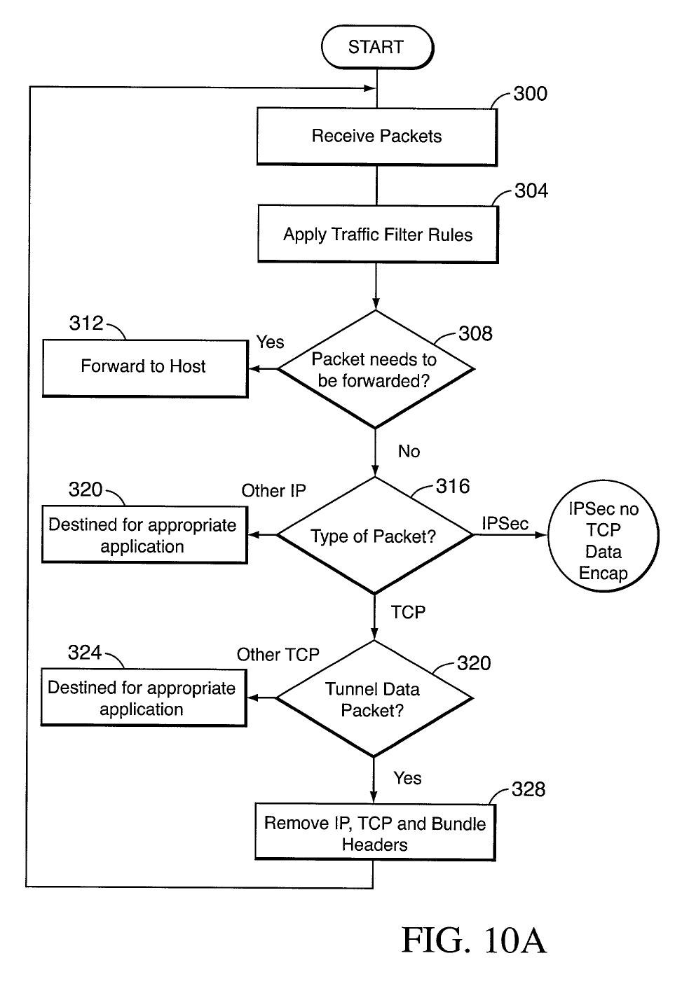

FIGS. 9A and 9B show a flow chart of the process for transferring packets from a private LAN, through the gateway to the Public Network. In step 210, a packet is received from the LAN (private network) and a request is made to transmit the packet over the Public Network, in step 214. In step 218, if the packet is not IPSec encapsulated, then the IPSec Security database is searched, in step 222, and if an IPSec Flow does not exist (a data structure that determines where to send the IPSec traffic, and what encryption and authentication schemes to use), as determined in step 226, then IP filter rules are applied to the packet, in step 230, and the packet is transformed to become an IPSec packet, in step 234. Then next time through the loop, in step 218, it is discovered that the packet is IPSec encapsulated, and the routing table is consulted, in step 238. Next, IP Filter rules are applied to the non-VPN traffic, but IPSec traffic is passed in step 242. If the IPSec packet is destined for a bundle, as determined in step 246, then the IVC Bundle Process is invoked. Otherwise, in step 250, the packet is output via a PPP link with an IP address from the routing table.

The IVC Bundle Process is shown in FIG. 7B. This process handles packets that are sent from the Initiator to the Responder via the secured VPN. In step 254, it is determined whether or not, it is necessary to TCP encapsulate the data. Recall that TCP encapsulation may be necessary to allow the IPSec packets to pass through firewalls and other barriers. If the packet needs no TCP encapsulation, then in step 258, an Inferior Virtual Circuit is chosen. The packet is then fragmented up to size MTU in step 262, and the IPSec IP header is translated to match the IVC in step 266.

In step 270, the Network Directed Routing Module uses the IP Filter to match the IVC address with PPP interfaces and, in step 274, forwards the packet to the correct PPP link.

In step 278, if there is more data in the packet to be sent, the process loops back to the beginning of the IVC Bundle Process to send the additional data. Otherwise, it returns to the starting point.

If TCP encapsulation is required, as determined in step 254, the packet is fragmented to the chosen fragment length, in step 282, and an IVC is chosen for the TCP stream, in step 286. Next, the packet is TCP encapsulated and the IP and Bundle headers are prepended, in step 290. The process then continues at step 270.

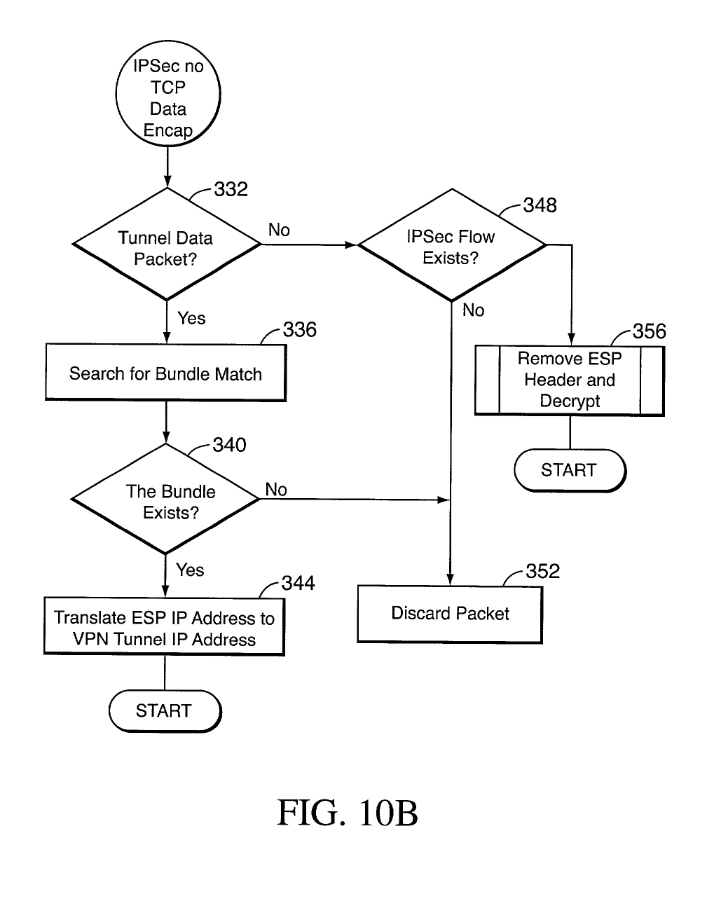

FIGS. 10A and 10B show a flow chart that illustrates the process of receiving a packet over the VPN. In step 300 of FIG. 10A, the packet is received and in step 304, the traffic filter rules are applied to the packet. If, as determined in step 308, the packet should be forwarded to the host, then in step 312, the packet is so forwarded. Otherwise, a test is made, in step 316, to determine the type of packet. If the packet is other than an IPSec packet, then in step 320, it is sent to the appropriate application. If, as determined in step 316, the packet is an IPSec packet, the IPSec_no_TCP_Encap routine is invoked. If, instead, the packet is TCP Encapsulated, then it is determined, in step 320, whether or not the packet is non-tunnel TCP packet. If it is a non-tunnel packet, then it is sent to the appropriate application in step 324; otherwise the IP, TCP and Bundle headers are removed in step 328 and the flow continues at the start of FIG. 10A to once again determine the type of packet to see if it is an IPSec packet.

The IP_no_TCP_Encap routine is illustrated in FIG. 10B. If, as determined in step 332, the packet is a tunnel data packet, then a search is made for a bundle match, in step 336. If the bundle exists, as determined in step 340, then the process translates the ESP IP Address to the VPN Tunnel IP Address in step 344, and returns to the beginning of the flow in FIG. 10A.

If the packet is not a tunnel packet, as determined in step 332, and if no IPSec Flow exists, as determined in step 348, then the packet is discarded in step 352. If there is no bundle for a tunnel packet as determined in step 340, then the packet is also discarded in step 352. Finally, if the packet is not a tunnel packet and an IPSec flow does exist, then in step 356, the ESP header is removed and the packet is decrypted. Process flow returns to the start in FIG. 10A.

FIG. 11 shows a flow chart of the TCP encapsulation sequence. Starting with a Data IP Packet, in step 360, if no TCP encapsulation is used as determined in step 364, then, in step 368, an address translation is performed and in step 372, Network Directed Routing is added. If TCP encapsulation is used, then in step 376, a bundle header is prepended to the packet, in step 380, a TCP header is prepended to the packet in step 380, and in step 384, a final IP header is prepended. Finally, in step 372, the Network Directed Routing is added. Relying on address translation with NDR to avoid additional TCP encapsulation provides the lowest packet overhead and highest performance when transferring tunnel data.

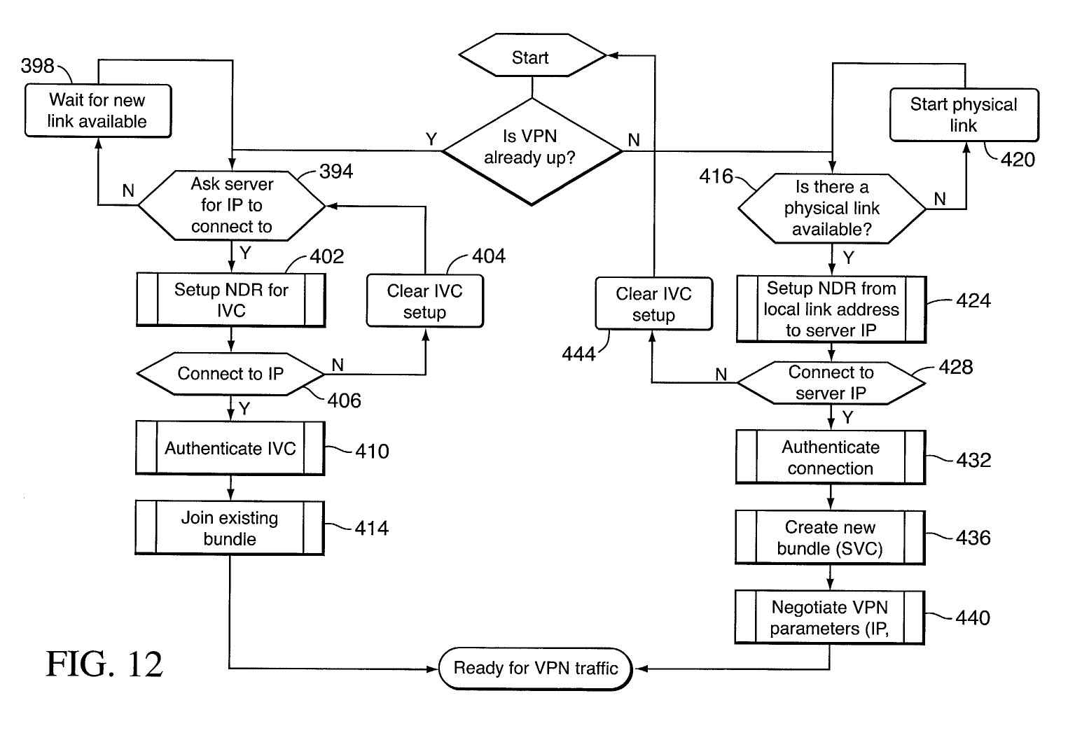

FIG. 12 shows a flow chart of the process for negotiating additional IVCs for a SVC. If the VPN is already established as operational, as determined, in step 390, a request is sent to the Responder gateway for an IP address to connect to, in step 394. If there is no link available, the process waits for an available link, in step 398. If and when an link is available, the NDR for the IVC is setup in step 402. Next, in step 406, a request is made to connect to the remote IP address that was requested from the Responder gateway. If the request is successful, the IVC is authenticated, in step 410, and joined to the existing bundle, in step 414. Otherwise, in step 406, if the request was not successful, the process clears the IVC setup in step 404, and returns to ask the Responder for an IP Address to connect to.

If the VPN is not established, then a request for a physical link is made in step 416, and when the link becomes available in step 420, an NDR association is setup between the local link address and the Responder gateway IP address in step 424. Next, in step 428, a request is made to connect to the Responder gateway IP address. If the request is granted, then, in step 432, the connection is authenticated, and in, step 436, a new SVC (bundle) is created. In step 440, the process negotiates VPN parameters. If the request to connect to the Responder IP is denied in step 428, then the IVC setup is cleared, in step 444, and the process returns to start anew.

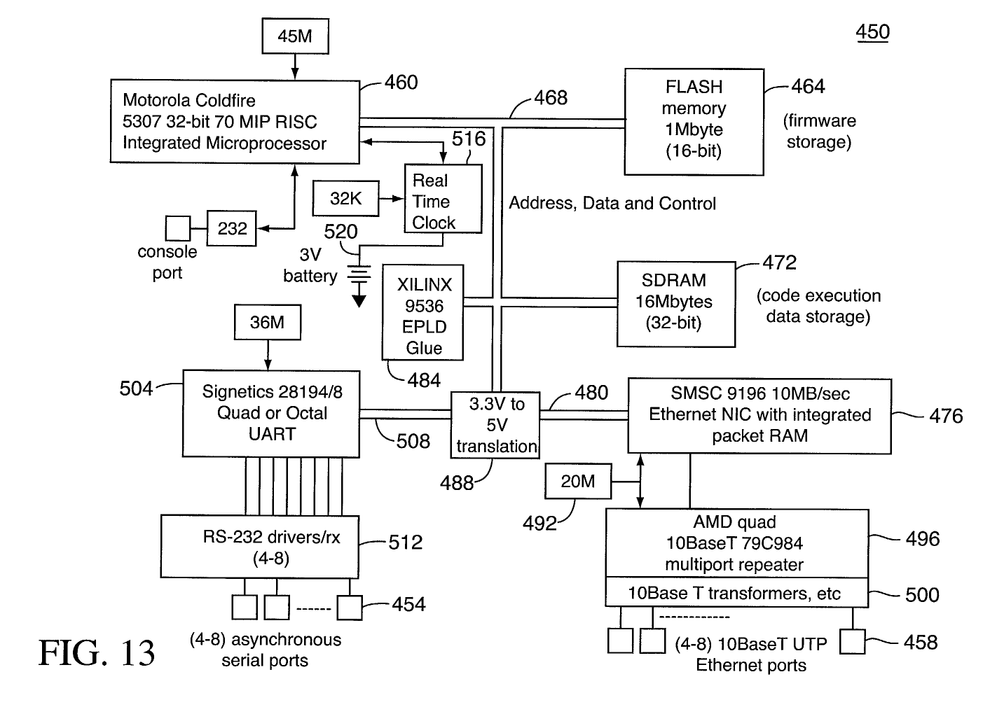

FIG. 13 shows a block diagram of a gateway system, in accordance with the present invention. This gateway system (called a Small Network Gateway, SNG) 450 is a special purpose computing system that functions as an Internet router and secure VPN access server to provide local network node connections (Ethernet) and remote dial-up connections (supporting analog moderns or ISDN T/As) which are consistent with small business computer networks and telecommunications infrastructure. The Small Network Gateway includes a circuit board assembly that is populated with electronic components and housed in a plastic enclosure with a number of external accessible sockets, which are grouped in order of function. Asynchronous RS-232 serial ports 454 occupy four to eight sockets on the board. These ports facilitate the external attachment of multiple modems, ISDN T/As or the like, for remote dial-up connections.

Another set of four to eight sockets 458 provides an IEEE 802.3 10BaseT multi-port physical repeater (or HUB) for the connection of a number of personal computers or server computers. These computers must be equipped with 10Base-T Ethernet controllers/cards and configured with TCP/IP networking services. The controlling electronics provides the connectivity to form a Local Area Network allowing all the computers to share in the functionality that the gateway provides. The Small Network Gateway can support 8 Ethernet node connections to provide a LAN via the HUB for PCs, and 8 serial dial-up connections (which can be bundled) in a single unit, providing a cost-effective LAN HUB-WAN (via VPN and bundling) gateway with scalable bandwidth.

Referring to FIG. 13, the core of the hardware is the Motorola MCF5307: Integrated ColdFire® Version 3 Microprocessor 460 that delivers 70 MIPs at 90 MHz using a 45 MHz clock source. The device also incorporates peripherals and includes: 4 K Bytes of SRAM, a Multiply-Accumulate (MAC) unit and a Divide unit, 8 K Bytes of Unified Cache, a 4-channel DMA controller, a DRAM Controller, 2 UARTs, Dual 16-bit Timers, a 12C®-Compatible Bus, a System Interface, a System Debug Support, a Clock Multiplied PLL and a 16-bit parallel I/O port. The microprocessor executes all the gateway firmware code.

The operational firmware is stored in non-volatile 3.3 volt Flash Memory device 464, which is connected to the microprocessor address, data and control buses 468 in a 512k×16-bit configuration (1 M Byte). Certain sectors within the flash memory are dedicated to storing and retrieving configuration parameters. At the end of the boot process after power-up, the firmware is relocated into 3.3 volt SDRAM 472 and the microprocessor executes all the code from this bank of random access memory. The SDRAM is connected to the microprocessor in a 4-M×32-bit configuration (16 M Bytes) which also provides address multiplexing and command generation.

An Ethernet NIC 476, with an integrated 6K Bytes of packet RAM, provides an Ethernet node connection. This device connects to the microprocessor over a 16-bit data bus 480 with four address lines providing register selection. The NIC 476 also provides an interrupt signal for notification of successful commands, errors, etc. One of the EPLDs 484 generates compatible timing strobes for the device. Because the NIC 476 is a 5-volt device, the microprocessor address and data buses are translated to 5-volt levels using 74LCX buffers 488.

The NIC 476 operates from a 20 MHz clock source 492 that also feeds the 10Base-T multi-port repeater device 496. To enable the NIC 476 and up to 8 external computers to successfully communicate over the LAN, the NIC data port is wired to the AUI on the multi-port repeater device 496. The multi-port repeater device 496 is fitted with external termination resistors and transformers 500 for each channel providing multiple complete 10Base-T connections on the RJ-45 connectors 458.

Asynchronous serial interfaces are provided by a quad or octal UART 504 operating at 36 MHz. The UART interfaces to a 5-volt 8-bit data bus 508. Eight address lines provide channel selection, etc., while the timing strobes provided by the second EPLD 484. The device can generate a composite interrupt to alert the microprocessor of successful command completion, errors, etc.

The device incorporates a vectoring scheme that facilities simple decoding of per channel interrupts. It also provides 16-byte data FIFOs for every receiver and transmitter. This reduces interrupt latency constraints on the microprocessor and reduces the possibility of data overruns. The device also performances out of band automatic flow control over the control lines Request-to-Send (RTS) and Clear-to-Send (CTS) as well as in-band software flow control. To provide RS-232 compliant asynchronous serial ports, driver and receiver devices 512 translate the quad/octal UART serial data and control signals. Each port can operate at speeds up to 230.4 Kb/sec for connection to external modems, ISDN T/As, etc.

The real-time clock device 516 interfaces to the microprocessor 460 using a two wire serial 12C®-Compalible Bus. The battery 520 keeps the device powered in the event of external power loss. This device can be used to time on-demand dialing for the serial ports that can bring up modem connections to ISPs as required or bring them down as required. It may be useful to have all the connections down outside of working hours or on the weekend, for example.

This design delivers scalable bandwidth to 512 KBPS depending on the number of analog or ISDN Internet connections and the level of bulk data encryption used on the tunneled data. The design is suited to businesses with a small number of remote sites.

The Small Network Gateway Apparatus 450 incorporates an embedded, UNIX-like operating system, TCP/IP compliant networking stack which implements both the network layer and the transport layer and includes additional protocols, utilities and applications. Device drivers for devices such as NICs, UARTs, timers, etc. are also included in the firmware, enabling communications with computer systems on a LAN as well as remote systems over multiple dialup modem or ISDN connections. An IPSec security module provides privacy and authentication services for tunnel packets. The VPN manager, Bundle and Link manager sub-systems provide the Internet PPP connection bundling and communicate with the embedded TCP/IP stack and IPSec security module through the operating system.

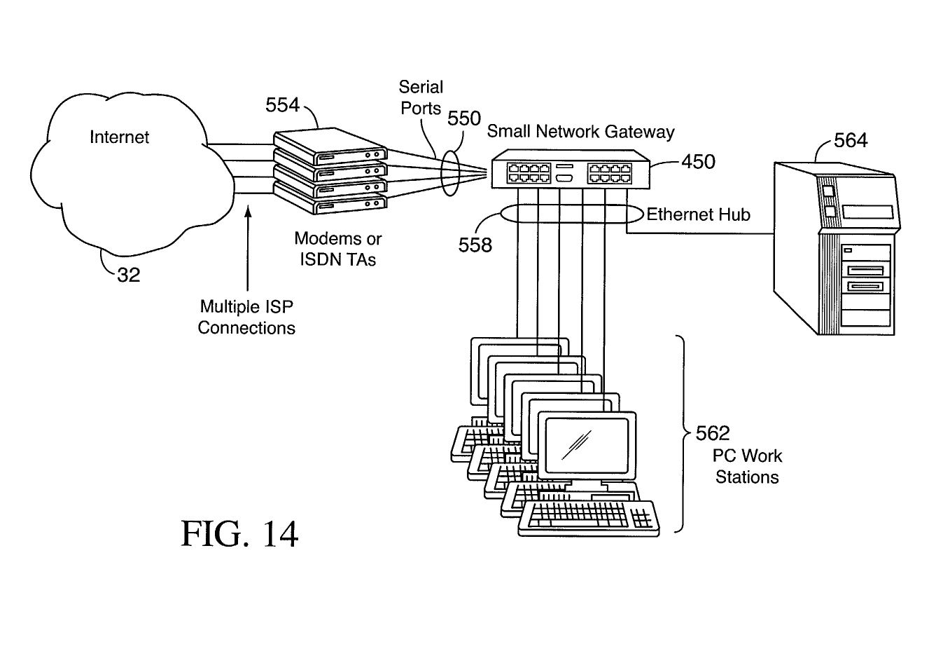

FIG. 14 shows a typical system that can be supported by the Small Network Gateway. The serial ports 550 connect to modems or ISDN TAs 554 which in turn make multiple ISP connections to the Internet 32. The Ethernet ports 558 connect to a number of PC Workstations 562 and to a Server computer 564.

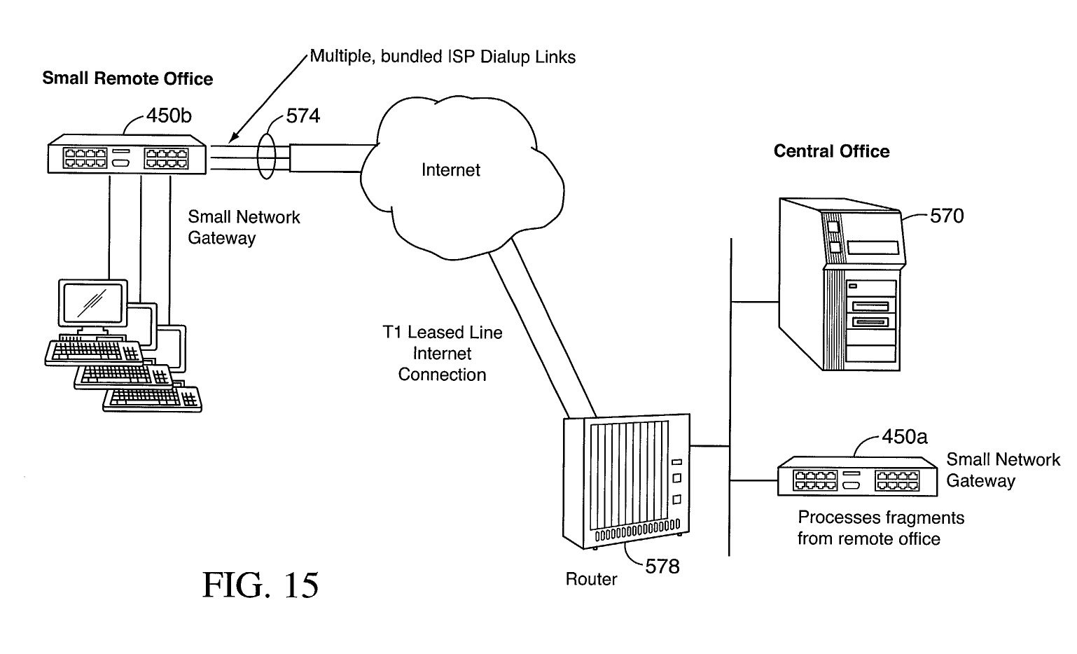

FIG. 15 shows another typical installation that can supported by the SNG 450. In the figure there is a central office 570 that connects to the Internet with a T1 line and a small remote office 450b that connects to the Internet 32 via standard ISP Dialup links 574. This installation requires an SNG 450a at the central office and another SNG 450b, at the remote site. Packets are tunneled through the router 578 at the central site to the SNG 450a, which processes the tunneled packet fragments from the remote office 450b.

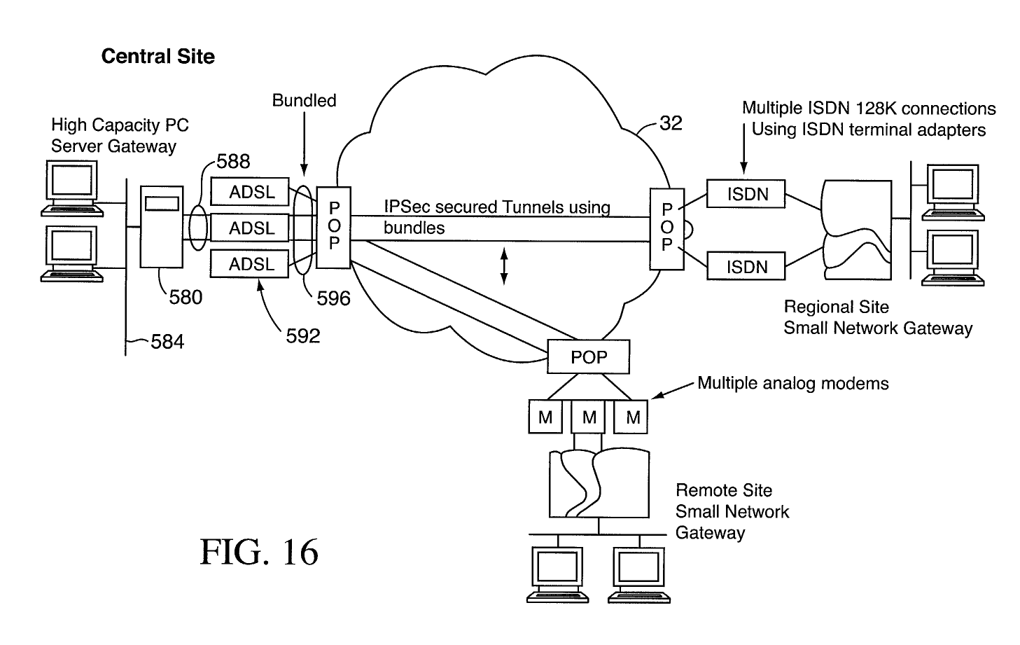

FIG. 16 an alternative embodiment of the present invention which includes a standard or industrial server PC computer 580 for high capacity implementations. The Server PC 580 has two Ethernet LAN segments 584, 588. A trusted segment 584 connects to the private LAN through an Ethernet hub, while an untrusted segment 588 connects to a collection of cable modems, ADSL modems 592 and routers that are in turn connected to the Internet 32. In this case, the present invention contemplates bundling Internet connections into a secure Tunnel to another site.

The server computer 580 has at least a Pentium-class central processing unit (or multiples thereof) with 128 M Bytes or more of RAM, magnetic disk storage, removable magnetic or optical media such as a diskette and CD-ROM, and two or more 10/100 MBPS Ethernet network interfaces. The operating system of the server computer can be any multi-tasking 32-bit or 64-bit operating system such as Linux, OpenBSD, SCO UnixWare, Solaris and Windows 2000. However, the invention is not limited to this hardware architecture or this list of operating systems.

The high capacity implementation on an open PC server gateway is recommended for installations that require a very large number of small network gateways, using multiple connections, to have tunnel connections to a central network. The central network also acts as a termination point and is often connected to the public network with a single high-speed connection. One of the Ethernet interfaces connects to the private, trusted network while the other may connect to a DSL modem, Cable modem, and dedicated T-1 or Frame Relay routers. These in turn connect to the un-trusted public network.

The present invention adds VPN, Bundle and Link manager software subsystems, which provide the Internet connection bundling and communicate with the embedded TCP/IP stack and IPSec security modules through the chosen operating system. Even though the central termination point often has only one connection it must also implement packet fragmenting, sequencing, buffering, fragment encapsulation, and packet re-assembly, in order for the remote small network gateways to benefit from the speed afforded by their multiple connections.

In addition, the PC server gateway can also bundle connections across multiple external routers, DSL modems or cable modems, in order to provide a higher aggregate bandwidth to other PC server gateway peers. ADSL 596 connections often suffer from line quality while cable modems may suffer from congestion problems. Certain areas serviced by ADSL may only reach a small fraction of the maximum line capacity due to their distance from the ADSL access multiplexers. Both of these services are usually asymmetric with vastly different downstream and upstream speeds because they were developed primarily for downloading Web material from content providers. In a bi-directional site-to-site connection, the upstream speed of the connection will govern the bandwidth. The present invention allows the site-to-site bandwidth (i.e., upstream) to scale by using multiple ADSL or cable modem connections in parallel, without any need to modify the access equipment at the provider. This also enables the PC server gateway to scale in bandwidth and provide multi-megabit tunnel throughput to service a very large number of small network gateways at remote locations. The latter is particularly useful to Application Service Providers (ASP) that provide outsourcing of their clients fundamental MIS, accounting etc., applications onto server computers at their PoPs. Clients use Internet-enabled thin-client applications at their sites to transact with the server application at the ASP. The small network gateways provide the client's office network with secure tunnels, built on multiple connections, which have been aggregated, to the ASP to provide cost-effective bandwidth.

Another embodiment of the present invention requires improvements to popular router firmware, which already contains its own operating system. The improvements to the router firmware provide a gateway function and include packet fragmenting, sequencing buffering fragment encapsulation and packet re-assembly in order for the remote small network gateways to benefit from the speed afforded by their multiple connections. This implementation is of major benefit to organizations that have a significant investment in pre-existing high-speed routers at their regional and central offices. The router device embodiment enables a very large number of small network gateways, using multiple connections, to have tunnel connections to a central network. The router operating system requires support for IPSec and many other Internet protocols and services which are upgraded to provide the packet processing that is consistent with channel aggregation of the present invention.

Although the present invention has been described in considerable detail with reference to certain preferred versions thereof, other versions are possible. Therefore, the spirit and scope of the appended claims should not be limited to the description of the preferred versions contained herein.

What is claimed is:

1. A method of forming a peer-to-peer, scalable bandwidth connection between a first computer system and a second computer system each connected to a public computer network, the method comprising the steps of:
establishing at least one physical point-to-point link between the first computer system and the public computer network, the first computer system link having a network address that is static and known to the second computer system;
establishing at least one physical point-to-point link between the second computer system and the public computer network, the second computer system link having a network address that is possibly unknown to the first computer system;
establishing an inferior virtual circuit to interconnect the first and second computer systems using the physical links and the public computer network;
establishing a superior virtual circuit between the first computer system and the second computer system, the superior virtual circuit comprising a plurality of inferior virtual circuits, each inferior virtual circuit including at least one unique physical point-to-point link not used by any other virtual link;
wherein the bandwidth of the superior virtual circuit is scaled by establishing additional physical point-to-point links between either the first or second computer system and the public network and establishing new inferior virtual circuit utilizing the additional physical point-to-point links; and
wherein the bandwidth available to the superior virtual circuit is equal to the minimum aggregate bandwidth of the available physical point-to-point links between either the first or second computer system.

2. A method of forming a peer-to-peer, scalable bandwidth connection between two computer systems connected to a public computer network as recited in claim 1, wherein the superior virtual circuit is formed by encapsulating network protocol data with a security protocol.

3. A method of forming a peer-to-peer, scalable bandwidth connection between two computer systems connected to a public computer network as recited in claim 2, wherein the security protocol is IPSec in tunnel mode.

4. A method of forming a peer-to-peer, scalable bandwidth connection between two computer systems connected to a public computer network as recited in claim 3, wherein bundling is achieved through network layer packet fragmenting when the IPSec in tunnel mode is extensible through a firewall.

5. A method of forming a peer-to-peer, scalable bandwidth connection between two computer systems connected to a public computer network as recited in claim 1, wherein, when the security protocol is blocked by a firewall, the security protocol is additionally encapsulated with a standard transport protocol to make the tunnel extensible through a firewall.

6. A method of forming a peer-to-peer, scalable bandwidth connection between two computer systems connected to a public computer network as recited in claim 5, wherein the standard transport protocol is TCP.

7. A method of forming a peer-to-peer, scalable bandwidth connection between two computer systems connected to a public computer network as recited in claim 1, wherein the first computer system connects to the public computer network through a local area network.
